(19) United States
(12) Patent Application Publication
(10) Pub. No.: US 2015/0015192 A1
(43) Pub. Date: Jan. 15, 2015

(54) WIRELESS TRACKING POCKET-FORMING

(71) Applicant: DvineWave Inc., San Ramon, CA (US)

(72) Inventors: Michael A. Leabman, San Ramon, CA (US); Gregory Scott Brewer, Livermore, CA (US)

(21) Appl. No.: 13/939,506

(22) Filed: Jul. 11, 2013

(51) Int. Cl. H02J 7/02; H01F 38/14; H04B 5/00

(52) U.S. Cl. CPC H02J 7/025; H04B 5/0037; H01F 38/14
USPC 320/108; 307/104

(57) ABSTRACT

The present disclosure describes a wireless tracking system for tracking the location of living beings or objects. This wireless tracking system may operate by using the wireless power transmission methodology which may include one transmitter and at least one or more receivers, being the transmitter the source of energy and the receiver the device that is desired to charge or power. Receivers and transmitters may include communications components to communicate between each other. Communication components may utilize wireless protocols which may have a unique identifier. The unique identifier may allow mapping, store and uploading information of devices a database located in public or private cloud-based service. A user may be able to access to information stored in database using user credentials, being able to access from any suitable device and place. Other elements may be adapted to wireless tracking system for obtaining more complete information about living beings or objects.

### CROSS-REFERENCES TO RELATED APPLICATIONS

The present disclosure is related to U.S. Non-Provisional patent application Ser. Nos. 13/891,430 filed May 10, 2013, entitled “Methodology For Pocket-forming” and 13/925,469 filed Jun. 24, 2013, entitled “Methodology for Multiple Pocket-Forming” the entire contents of which are incorporated herein by these references.

### FIELD OF INVENTION

The present disclosure relates to electronic transmitters, and more particularly to transmitters for wireless power transmission.

### BACKGROUND OF THE INVENTION

There are many tracking systems that have evolved for observing, controlling, monitoring, and identifying living beings or objects. The tracking systems follows the movement of living beings and objects for supplying a timely ordered sequence of respective location data to a model; for example, a tracking system that depicts the motion of an animal through a suitable interface such as a display,

Some of the systems utilized for tracking living beings or objects may be a GPS (Global Positioning System) and a Real-time Locating System which may be integrated or adapted to suitable devices. Usually, these tracking systems applied in devices may include a battery, a signal receiver, and a transmitter. However, these tracking devices may not result successful due to the battery life charge may not last for sufficient time and the user may be forced to plug it in or remove the battery from the device to gain charge and achieve the tracking purpose. Furthermore, these tracking devices may result expensive when other services are adapted, such as statistics reports.

Charging the battery or plug in to a power source may result a tedious activity and may represent a burden to users. Current solutions to this problem may include inductive pads which may employ magnetic induction or resonating coils. Nevertheless, such a solution may still require that these tracking devices may have to be placed in a specific place for powering. Thus, tracking devices during charging may not be portable.

For the foregoing reasons, there is a. need for cost-effective wireless power transmission system where these tracking devices may be powered without requiring extra chargers or plugs, and where the functionality of this tracking devices may not be compromised.

### SUMMARY OF THE INVENTION

The present disclosure describes a wireless tracking system for tracking, controlling, monitoring, and identifying living beings and objects using wireless power transmission on a pocket forming. The following wireless tracking system may operate by having one transmitter and one or more receivers adapted or integrated to a living being and objects.

In an embodiment, a description of pocket-forming methodology using at least one transmitter and at least one receiver may be provided.

In another embodiment, a transmitter suitable for pocket-forming including at least two antenna elements may be provided, and a receiver suitable for pocket forming including at least one antenna element may be provided.

In a further embodiment, wireless tracking system may be used determining the location of objects or living beings by using a wireless power transmission on pocket-forming.

In an even further embodiment, in order to track the location of a determined living being or object, a cloud-based service may be suitable for finding the location of receiver.

Yet, in another embodiment, wireless tracking system may be programmed to send notifications when living beings or objects are not in the place where it/she/he has to be.

Furthermore, wireless tracking system may optionally operate when receiver may include at least one audio component, such as a speaker or microphone.

Alternatively, in the wireless tracking system, transmitter may be connected to an alarm system.

The embodiments described in the following disclosure may provide an improved wireless tracking system for observing, controlling, monitoring, and identifying living beings and objects from any suitable device and/or place. Furthermore, the wireless tracking system may be extendable by integrating a variety of services that a user may require to supervise determined living beings or objects. In addition the workload of wireless tracking system may not be compromised by problems of power charging, because transmitter may be responsible to provide power or charge when receiver may require, without having to remove any battery or plug in to a power source.

These and other advantages of the present disclosure may be evident to those skilled in the art, or may become evident upon reading the detailed description of the prefer embodiment, as shown in the accompanying drawings.

### DETAILED DESCRIPTION OF THE DRAWINGS

### Definitions

“Pocket-forming” may refer to generating two or more RE waves Which converge in 3-d space, forming controlled constructive and destructive interference patterns.

“Pockets of energy” may refer to areas or regions of space where energy or power may accumulate in the form of constructive interference patterns of RF waves.

“Transmitter” may refer to a device, including a chip which may generate two or more RF signals, at least one RF signal being phase Shifted and gain adjusted with respect to other RF signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

“Cloud-based service” may refer to services or resources made available to users on demand via the Internet which

### BRIEF DESCRIPTION OF THE DRAWINGS

The present invention can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates wireless power transmission methodology that may be used for pocket-forming according to the invention.

FIG. 2 shows a transmitter including components that may he used for pocket-forming in wireless power transmission of FIG. 1.

FIG. 3 illustrates component level embodiment for a receiver used for pocket-forming according to the invention of FIG. 1.

FIG. 4 describes a wireless tracking system for uploading to a cloud service according to the invention of FIG. 1.

FIG. 5 is an exemplary wireless tracking system for tracking the location of a dog according to the invention FIG. 1.

FIG. 6 is an exemplary wireless tracking system for tracking and controlling the location of a woman that has conditional liberty in her house according to the invention of FIG. 1.

FIG. 7 is an exemplary wireless tracking system for tracking and controlling commodities of generators stored inside a cellar according to the invention of FIG. 1.

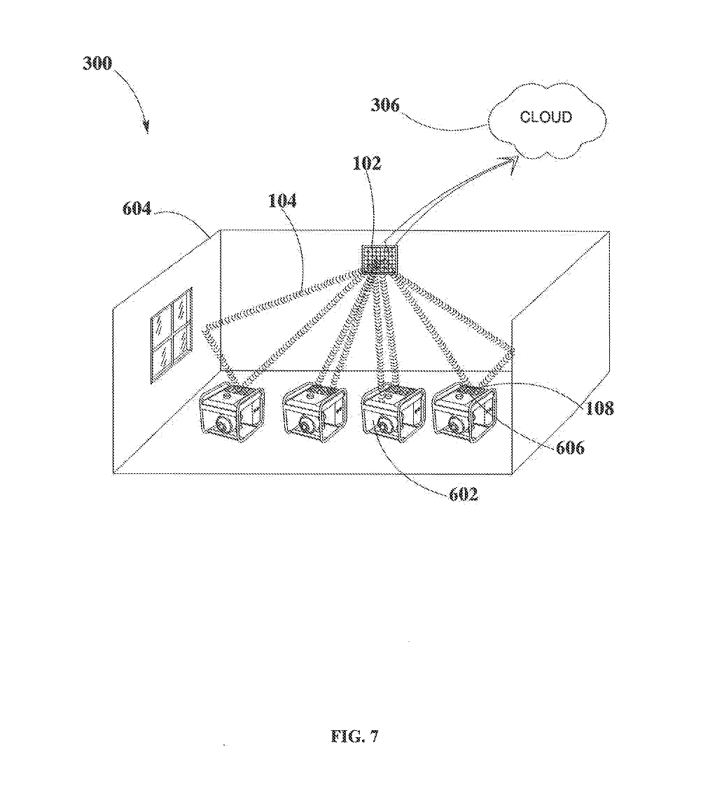

### DESCRIPTION OF THE DRAWINGS

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

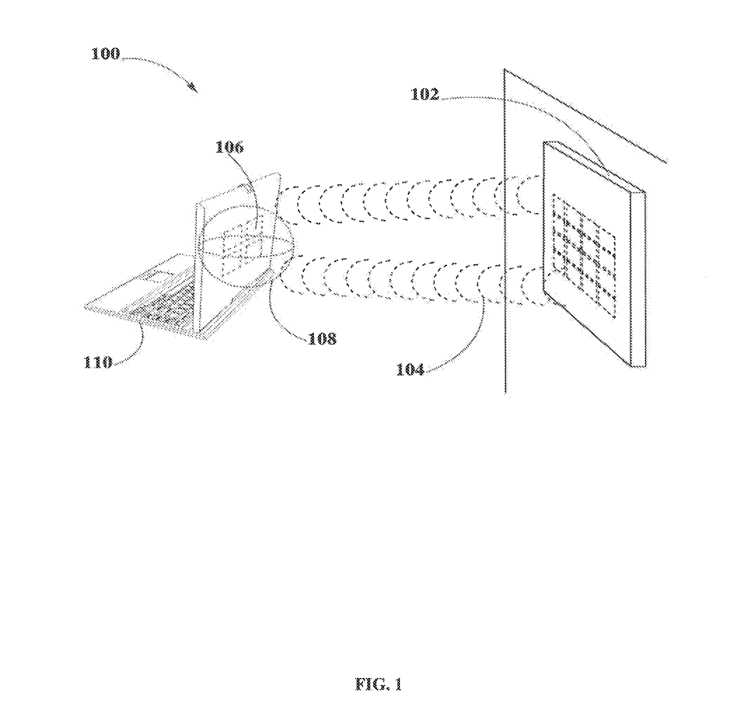

FIG. 1 illustrates wireless power transmission 100 that may be used for pocket-forming. A transmitter 102 may transmit controlled Radio Frequency (RF) waves 104 which may converge in 3-d space. These RF waves 104 may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

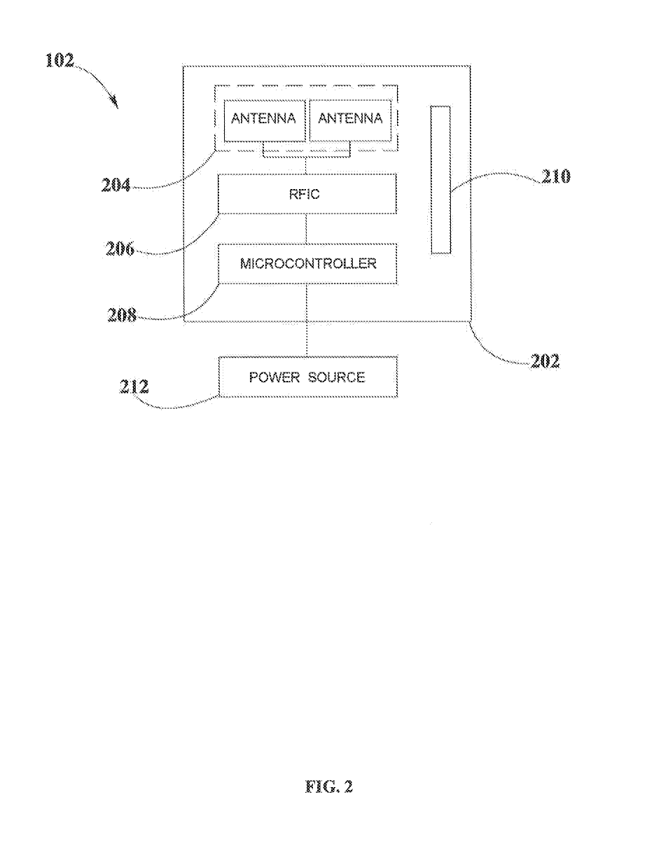

FIG. 2 illustrates transmitter 102 and receiver 108 including components that may be used for pocket-forming in wireless power transmission 100. These components may not intend to limit the disclosure, other components may be added, modified or replaced in transmitter 102 and receiver 108 devices.

FIG. 2 illustrates a component level embodiment for transmitter 102 Which may be used for pocket-forming. In this embodiment, transmitter 102 may be used to provide wireless power transmission 100. Transmitter 102 may include a housing 202 having at least two or more antenna elements 204, at least one RF integrated circuit (RFIC 206), at least one digital signal processor (DSP) or micro-controller 208, and one communications component 210. Housing 202 may be made of any suitable material Which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about 1/24 inches to about 1 inch and widths from about 1/24 inches to about 1 inch, Micro-controller 208 may then process information sent by a receiver 108. Typically, receivers 108 may communicate to transmitter 102 through short signals (such as RF) or through communications component 210 for determining optimum times and locations for pocket-forming. Communications component 210 may be based on standard wireless communication protocols which may include Bluetooth, Wi-Fi or ZigBee. Transmitter 102 may also include an external power source 212.

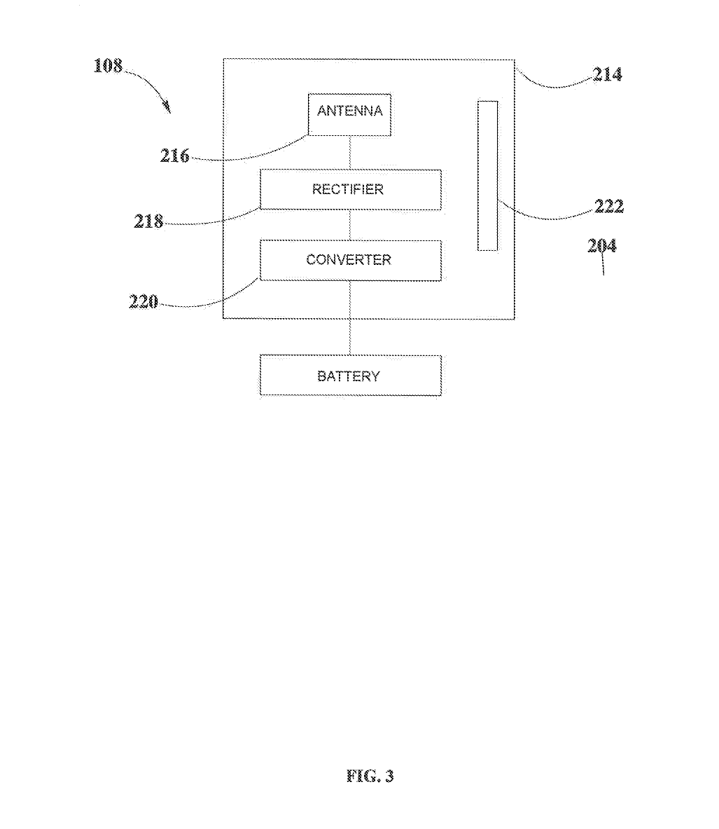

FIG. 3 illustrates a component level embodiment for receiver 108 which may be used for pocket-forming. In this embodiment, receiver 108 may be used for powering or charging an electronic device. Receiver 108 may also include a housing 214 having at least one antenna element 216, one rectifier 218, one power converter 220 and one or more communications component 222, Housing 214 can be made of any suitable material which may allow for signal or wave transmission and/or reception, for example plastic or hard rubber. Furthermore, housing 214 may be light, resistant to heat, water, corrosion resistant, durable, and adaptable to different types of environments (eg., resistant to climate changes). In addition, housing 214 may be an external hardware that may be added to different electronic equipment, for example in the form of cases, or can be embedded within electronic equipment as well. Antenna element 216 may include suitable antenna types for operating in frequency bands such as those described for transmitter 102 from FIG. 2. Antenna element 216 may include vertical or horizontal polarization, right hand or left hand polarization, elliptical polarization, or other suitable polarizations as well as suitable polarization combinations. Rectifier 218 may be configured to convert the signal (e.g., an RF signal) received by antenna element 216 into a voltage (e.g., DC). Power converter 220 may be used for regulating the voltage obtained from rectifier 218 in order to obtain an appropriate output voltage for charging or powering an electronic device. As described above, receiver 108 may communicate with transmitter 102 using short signals (such as RF) or through communications component 222 as described in FIG. 2.

In some embodiments, receiver 108 may be implemented externally to electronic devices in the form of cases, e.g. camera cases, phone cases and the like which may connect trough suitable and well known in the art techniques such as universal serial bus (USB). In other embodiments, receiver 108 may be embedded within electronic devices.

In another embodiments, receiver 108 may he implemented in tracking systems for observing, following, and recording the movement of people, animals, or objects in determined period of time. Receivers 108 may be adapted to living beings or objects in a variety of forms such as including receivers 108 in bracelets, necklaces, belts, rings, ear chips, and watches, among others. In addition, the implementation of receiver 108 in tracking systems may be complemented with the use of a transmitter 102 which may he employed for locating receiver 108 through RF waves 104. Furthermore, receiver 108 along with transmitter 102 may allow that tracking systems may not be interrupted; due to receiver 108 may always be charged or powered by RF waves 104. Alternatively, receiver 108 may be adapted to GPS, real-time location systems or other existent tracking systems for finding, monitoring and controlling the location of living beings such as animals or humans, and/or the location of objects such as cars, electronic devices, and commodities, among others.

FIG. 3 describes a wireless tracking system 300 for determining the location of objects or living beings. In this embodiment, wireless tracking system 300 may be applied in a wireless power transmission 100 using pocket-forming. Transmitter 102 may be in house 302 placed on a suitable location, such on a wall, for an effective wireless power transmission 100 to electronic device 304. Objects or living beings may use an electronic device 304 with embedded or adapted receiver 108. Receiver 108 may include all the components described in FIG. 3 and transmitter 102 may also include all components described in FIG. 2.

Receiver 108 may communicate with transmitter 102 by generating a short signal (e.g., RF) through antenna elements 204 in order to locate its position with respect to the transmitter 101 Receiver 108 may utilize at least one communications component 210, which may enable receiver 108 to communicate with other devices or components. Communications component 222 may enable receiver 108 to communicate using a wireless protocol. As described in FIG. 2A and FIG. 2B, the wireless protocol may be a proprietary protocol or use a conventional wireless protocol such as Bluetooth, Wi-Fi, ZigBee, etc. Communications component 222 may also be used to transfer information to transmitter 102 such as an identifier for the electronic device 304 or a user that owns electronic device 304 which require to be charged, battery level information for a connected electronic device 304, geographic location data, or other such information that may be useful in determining when to send power to receiver 108, as well as the location at which to send the power for charging or powering an electronic device 304. Communications component 222 may also include information about the same utilized receiver 108, such as the number of antenna elements 204, size and arrangement of those elements, power capacity, and other such information that can help to determine the size at which to focus the beam (e.g., RF signal), as well as how much power should be transmitter 102 via the beam of RF waves 104. Other such information may be communicated as well, such as account information for use in charging or powering the user's electronic device 304, or ensuring that the user, electronic device 304, and/or receiver 108 is authorized to receive power. Various other information may be transmitted as well in other embodiments.

While transmitter 102 may charge or power receiver 108, micro-controller 208 (from transmitter 102) may be able to process the information provided by communications component 222 from receiver 108, as described above. This information may be repeatedly uploaded to a cloud-based service 306 to be stored in a database in determined intervals of time. Through data stored in database, the information may be read through a suitable interface such as computer software from any suitable computing device and from any suitable location. Transmitter 102 may use a unique identifier of receiver 108 for identifying and tracking electronic device 304 from other devices. The unique identifier of receiver 108 may be according to the type of communications component 210 that may be used in receiver 108; for example, if a Wi-Fi protocol is used, the MAC address may be the unique identifier. This unique identifier may allow the information of electronic device 304 with receiver 108 to be mapped and stored in the database stored in cloud-based service 306. Other unique identifiers may include International Mobile Equipment Identity (IMEI) numbers, Which usually comprise a 15-digit unique identifier associated with all GSM, UMTS and LTE network mobile users; Unique Device ID (UDID) from iPhones, iPads and IPods, comprising a combination of 40 numbers and letters set by Apple; Android ID, which is set by Google and created when a user first boots up the device; or International Mobile Subscriber Identity (IMSI), which is a unique identification associated. with the subscriber identity module (SIM). Furthermore, user may be able to obtain user credentials to access the database stored in a private or public cloud-based service 306 to obtain the information of receiver 108. In this embodiment, cloud-based service 306 may be public when the service, provided by the same transmitter 102 or wireless manufacturer, is utilized in the public network by using only the user credentials for obtaining the desired information. And, cloud-based service 306 may be private When transmitter 102 may be adapted to a private network that has more restrictions besides user credentials.

In another embodiment, in order to track the location of a determined living being or object, a cloud-based service 306 may be suitable for finding the location of receiver 108. For example, in FIG. 3 when receiver 108 may not be in house 302, a user may be able to access with user credentials to a suitable interface such as an interne explorer, to visually depict the places where receiver 108 was located, using information uploaded in database from the cloud-based service 306. Also, if receiver 108 may reach power or charge from another transmitter 102 located in public establishments such as stores, coffee shops, and libraries, among others, the information may be uploaded to cloud-based service 306, where user may also be able to depict the information stored in the cloud-based service 306.

Yet, in another embodiment, wireless tracking system 300 may be programmed to send notifications when living beings or objects are not in the place where it/she/be has to be. For example, if a cat is not at owner's home, a notification such as an interactive message may be sent to a cellphone notifying that the cat is not at home. This interactive message service may be adapted to cloud-based service 306 as an extra service. The interactive message may be optionally sent to an e-mail or to a computer software as it may be desired. Furthermore, additional information may be included in the interactive message such as current location, time, battery level of receiver 108, among other type of data.

Yet, in another embodiment, wireless tracking system 300, may operate when receiver 108 may include at least one audio component, such as a speaker or microphone, which may enable location determination via sonic triangulation or other such methods.

Yet, in another embodiment, transmitter 102 may be connected to an alarm system which may he activated when receiver 108 is not located in the place where it has to be.

### EXAMPLE

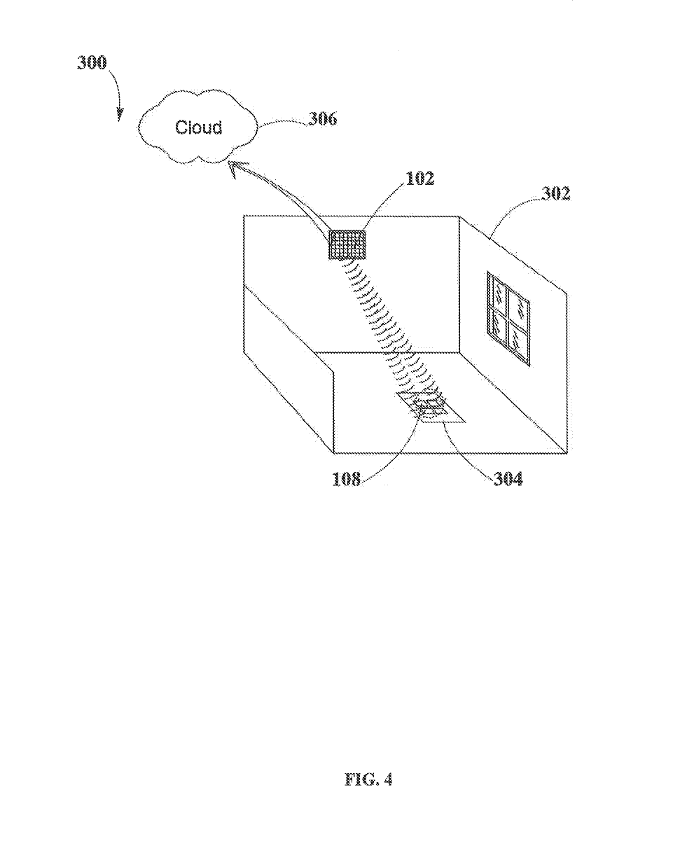

In example #1, in FIG. 4 is an exemplary wireless tracking system 300 for tracking the location of a dog 402. In this embodiment, dog 402 is wearing a necklace collar 404 that may include a chip 406 with an embedded receiver 108. Dog 402 may be outside first room 408 and inside second room 410. First room 408 may be the place where dog 402 lives; however dog 402 escaped and arrived at second room 410 from a coffee shop. In first room 408, a first transmitter 412 is hanging on a wall, and in second room 410, a second transmitter 414 is hanging on the wall too. Second transmitter 414 detects that dog 402 is not at home, here the interruption of RF waves 104 transmission to receiver 108 from necklace collar 404 allows first transmitter 412 to detect the absent of dog 402 in first room 408. In FIG. 4, the type of communication component 210 to communicate first transmitter 412 or second transmitter 414 with receiver 108, is a Wi-Fi protocol.

Subsequently, the owner of dog 402 receives a message notification informing that his/her dog 402 is outside second room 410. When dog 402 arrived at second room 410, receiver 108 received RF waves 104 from second transmitter 414, while this second transmitter 414 detects the presence of a new receiver 108 and uploads the location and time to database stored in the public cloud-based service 306. Afterwards, the owner of dog 402 accesses public cloud-based service 306 through a smartphone application for tracking the location of dog 402. The owner may have his/her credentials to access cloud-based service 306, where the user account is mapped with MAC address of first transmitter 412 and receiver 108. In the cloud-based service 306 is displayed the locations with determined times where dog 402 has been during its absence from first room 408, using the MAC address of receiver 108. Finally, the owner is now capable to rescue his/her dog 402 by knowing the current location where dog 402 is.

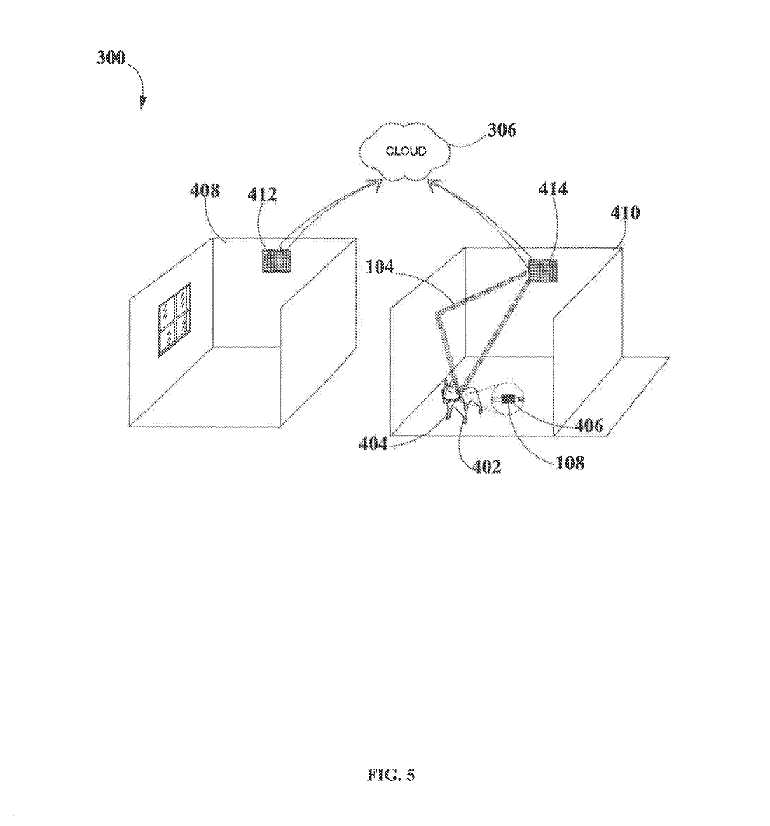

In example #2, in FIG. 5 is an exemplary wireless tracking system 300 for tracking and controlling the location of a woman 502 that has conditional liberty in her house 504. In this embodiment, woman 502 is wearing an ankle monitor 506 that may include a GPS chip 406 with an adapted receiver 108 to charge its battery. Ankle monitor 506 receives RF waves 104 from transmitter 102 that is hanging on a wail from house 504. Receiver 108 communicates with transmitter 102 through a ZigBee protocol. In this case, the unique identifier which is used to identify receiver 108 is Personal Area Network Identifier (PAN ID). Receiver 108 sends information to transmitter 102 about the battery status, how many times battery has been charged, battery age indicator, and cycle efficiency. This information may be uploaded to a private cloud-based service 30$ which is monitored by a police station that supervises woman 502. Further, transmitter 102 may include an alarm system which may be activated when receiver 108 is not receiving RF waves 104 or/and woman 502 is not in house 504. This alarm system provides an audio sound alert, while transmitter 102 sends a notification to computer software of police office.

In FIG. 5, woman 502 escaped house 504; therefore the alarm system is activated providing audio sound alert and a police office receives a message notification informing that woman 502 is outside house 504. Then, police officer detects the location of woman 502 in a map using the GPS chip 406 from ankle monitor 506. Further, police officer accesses to private cloud-based network to monitor the battery life and the last time when receiver 108 received RF waves 104. Police officer may also have his/her credentials to access private cloud-based service 306, where the user account is mapped with PAN ID of transmitter 102. In addition, if woman 502 arrived to a public place such as coffee shop, receiver 108 may upload information and location of woman 502 to public cloud-based service 306 which may be transferred to private cloud cloud-based service 306; this operation is used as a back-up tracking system in case GPS does not work appropriately. Finally, the woman 502 may be found and handcuffed by police officer due to location was provided by GPS and/or private-cloud based service.

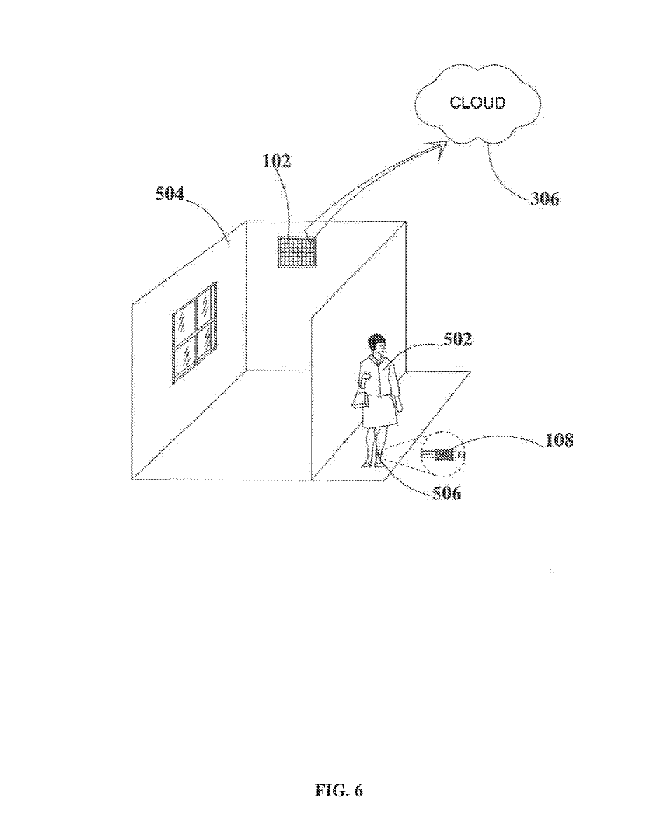

In example #3, FIG. 6 is an exemplary wireless tracking system 300 for tracking and controlling commodities of generators 602 stored inside a warehouse 604. Here, one transmitter 102 is used, which is hanging on a wall of warehouse 604. Each generator 602 has an electronic tag 606 with an adapted receiver 108. Transmitter 102 may transfer RF waves 104 to each receiver 108 for powering and tracking each electronic tag 606. The communication component 210 used in these receivers 108 is a Bluetooth protocol. In this embodiment, the unique identifier is UUID for the Bluetooth protocol.

If one or more generators are illegally subtracted from cellar facility, transmitter 102 activates an alarm and notifies a security guard through an interactive message informing that one or more generators 602 are being stolen. Security guard accesses to a cloud-based service 306 through an application and identifies generators 602 that were stolen through UUID of each electronic tag 606. Security guard receive another interactive message informing the current location of the stolen generators 602, in which this information was obtained when receivers 108 from electronic tags 606 receive RF waves 104 from other transmitter 102. This other transmitter 102 may uploaded the information of the current location of the stolen generators, allowing the guard finding these generators 602.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, I claim:

1. A method for wireless power transmission to a portable electronic device, comprising:
connecting a receiver to the electronic device;
developing pockets of energy from a pocket-forming transmitter;
transmitting wirelessly the pockets of energy to the receiver for charging and powering the electronic device; and
tracking a living being or an object from signals communicated between the receiver and the transmitter.

2. The method for wireless power transmission to a portable electronic device of claim 1, wherein the signals include an unique identifier related to the electronic device to track the living being or object.

3. The method for wireless power transmission to a portable electronic device of claim 2, wherein the unique identifier is a MAC address for WiFi, an International Mobile Equipment identity number, a 15-digit unique identifier for GSM, UMTS and LTE networks, Unique Device ID for iPhones, iPads and ipods, Android ID or International Mobile Subscriber identity for a SIM card.

4. The method for wireless power transmission to a portable electronic device of claim 1, wherein the receiver and transmitter each include a controller connected to a communication device for communications between the receiver and the transmitter to control the power and charging of the electronic device and to control the tracking, monitoring and identifying of the living being or the object.

5. The method for wireless power transmission to a portable electronic device of claim 4, further comprising the step of communicating between the receiver and transmitter through short RF waves or pilot signals on conventional wireless communication protocols including Bluetooth, Wi-Fi or Zigbee with data information for battery level, geographical location and the unique identifier.

6. The method for wireless power transmission to a portable electronic device of claim 5, further comprising the step of uploading the data information to a cloud based service for easy access by a tracking end user.

7. The method for wireless power transmission to a portable electronic device of claim 6, wherein the receiver is embedded in a bracelet, necklace, belt, ring, ear chips or a watch.

8. The method for wireless power transmission to a portable electronic device of claim 1, wherein the receiver is adapted to a GPS, a real-time location system or other existent tracking system for finding, monitoring and controlling the location of the living being or object.

9. The method for wireless power transmission to a portable electronic device of claim 1, wherein the living being is an animal or a human.

10. The method for wireless power transmission to a portable electronic device of claim 1, wherein the object is a car, electronic devices, commodities or other objects of value.

11. The method for wireless power transmission to a portable electronic device of claim 1, further including the step of implementing externally the connection of the receiver to the portable electronic device in the configuration of a case and further including the step of connecting the case to the electronic device through an universal serial bus or other suitable electrical connection.

12. The method for wireless power transmission to a portable electronic device of claim 1, wherein the portable electronic device is either a passive or an active RP integrated chip with a battery power source and the receiver embedded therein.

13. The method for wireless power transmission to a portable electronic device of claim 5, further comprising the step of transmitting simultaneously both Wi-Fi signals and power RF signals from the transmitter to the receiver.

14. A tracking method for wireless transmission of power to a portable electronic device, comprising:
supplying pockets of energy to a receiver including an antenna element, a digital signal processor (DSP), a rectifier, a power converter and a communications device connected to the electronic device with a battery;
pocket-forming in a transmitter including antennas, a RE integrated chip controlled by a DSP for generating the pockets of energy to charge or power the battery and a communication device controlled by the DSP;
communicating the power level of the battery and the geographical location of the receiver to the transmitter through short RE signals between the receiver and transmitter communication devices over conventional wireless communication protocols;
transmitting an unique identifier related to the electronic device and to the communication protocols from the receiver to the transmitter for tracking the location of the receiver and the connected electronic device.

15. The tracking method for wireless transmission of power to a portable electronic device of claim 14, further comprising the steps of:
decoding the short RE signals to identify the gain and phase of the receiver to determine the location of the receiver;
tracking, controlling, monitoring or identifying living beings or objects by the decoded short RF signals; and
charging the battery when in the proximity to the transmitter to provide an inexhaustible source of operating power for the electronic device.

16. The tracking method for wireless transmission of power to a portable electronic device of claim 14, further including the step of uploading the location of the electronic device to a cloud-based service.

17. The tracking method for wireless transmission of power to a portable electronic device of claim 14, wherein the receiver is a RE Chip connected to the electronic device.

18. The tracking method for wireless transmission of power to a portable electronic device of claim 14, wherein the electronic device includes an unique identifier related to a Wi-Fi MAC address, an international Mobile Equipment Identity number, an Unique Device ID, an Android ID or an international Mobile Subscriber ID.

19. The tracking method for wireless transmission of power to a portable electronic device of claim 15, wherein the receiver with the unique identifier is incorporated into a dog collar for tracking the location of the dog.

20. The tracking method for wireless transmission of power to a portable electronic device of claim 15, wherein the receiver with the unique identifier is incorporated into an ankle bracelet monitor for monitoring the location of a human being on a court supervision sentence.

21. The tracking method for wireless transmission of power to a portable electronic device of claim 14, further comprising the step of tracking a predetermined human being, animal or object.

22. The tracking method for wireless transmission of power to a portable electronic device of claim 16, wherein the cloud services are either public or private and require user credentials or authorization to gain access to accumulated data of the electronic device various locations over a period of time.

23. The tracking method for wireless transmission of power to a portable electronic device of claim 16, wherein the receiver is powered or charged from a transmitter located in a public establishment including stores, coffee shops, libraries, offices or manufacturing facilities.

24. A tracking system for wireless transmission of power to a portable electronic device, comprising:
a receiver connected to the portable electronic device with an antenna for receiving pockets of energy formed from constructive interference patterns of RF waves from a transmitter and for transforming the pockets of energy into an AC voltage;
a rectifier connected to the antenna for converting the AC Voltage into a DC voltage;
a power converter for changing the DC voltage into a constant DC voltage to Charge a battery in the electronic device;
an unique identifier associated with the receiver to send information including battery status, charging history and location history to a transmitter for tracking the electronic device.

25. The tracking system for wireless transmission of power to a portable electronic device of claim 24, wherein the receiver communicates with the transmitter through short RF waves or pilot signals sent through receiver and transmitter antennas, respectively.

26. The tracking system for wireless transmission of power to a portable electronic device of claim 24, wherein the receiver information is uploaded to a private or public cloud service requiring credentials to access.

27. The tracking system for wireless transmission of power to a portable electronic device of claim 24, wherein the receiver is embedded in a chip that is attached to a human being or an object to monitor the location of the human or object over a predetermined time interval.

28. The tracking system for wireless transmission of power to a portable electronic device of claim 24, wherein the receiver is externally connected to the portable electronic device in the form of a case with an universal serial bus or other electrical connection.
